(19) United States
(12) Patent Application Publication
(10) Pub. No.: US 2020/0355888 A1
(43) Pub. Date: Nov. 12, 2020

(54) OPTICAL LENS GROUP

(71) Applicant: Zhejiang Sunny Optical Co., Ltd., Zhejiang Province (CN)

(72) Inventors: Yu TANG, Zhejiang Province (CN); Xin ZHOU, Zhejiang Province (CN); Fujian DAI, Zhejiang Province (CN); Liefeng ZHAO, Zhejiang Province (CN)

(73) Assignee: Zhejiang Sunny Optical Co., Ltd., Zhejiang Province (CN)

(21) Appl. No.: 16/864,375

(22) Filed: May 1, 2020

(30) Foreign Application Priority Data
May 6, 2019 (CN) 201910371469.9

(51) Int. Cl. G02B 13/00; G02B 9/34; G02B 27/00

(52) U.S. Cl. CPC G02B 13/004; G02B 27/0025; G02B 9/34

(57) ABSTRACT

The present disclosure discloses an optical lens group including a first lens, a second lens, a third lens and a fourth lens having refractive power. An object-side surface of the first lens is convex and an image-side surface thereof is concave; an image-side surface of the second lens is concave; the fourth lens has a positive refractive power, an object-side surface thereof is convex, and an image-side surface thereof is concave, and at least one of the object-side surface and the image-side surface of the fourth lens has a inflection point. The optical lens group further includes a stop disposed between the first lens and the second lens. A radius of curvature R4 of the image-side surface of the second lens and a radius of curvature R3 of an object-side surface of the second lens satisfy 0.50<R4/R3<2.00.

### CROSS-REFERENCE TO RELATED APPLICATIONS

This application claims benefit of priority to Chinese Patent Application No. 201910371469.9 filed on May 6, 2019 before the China National Intellectual Property Administration, the entire disclosure of which is incorporated herein by reference in its entity.

### TECHNICAL FIELD

The present disclosure relates to an optical lens group, and more specifically, relates to an optical lens group including four lenses.

### BACKGROUND

With the continuous updating of Charge-coupled Device (CCD) and Complementary Metal-oxide Semiconductor (CMOS) image sensors, the application field thereof has expanded to the infrared light range. CCD and CMOS may be applied to applications such as infrared imaging, distance detection, infrared recognition and the like.

The continuous development of portable electronic products has put increasing demands on the miniaturization of camera lens assemblies. The current miniaturized camera lens assembly usually has a large F-number, and the incident angle of off-axis light on the imaging plane is large, resulting in a small amount of light entering, and the interference of non-effective band light will cause an unusable failure. In the application of the infrared field, both the miniaturization of the camera lens assembly and the characteristics of the large aperture and low interference must be ensured, so as to ensure the normal use of the lens assembly in detection, identification and other fields and have a better measurement accuracy.

### SUMMARY

The present disclosure provides an optical lens group, for example, a large-aperture optical lens assembly, that is applicable to portable electronic products and at least solves or partially addresses at least one of the above disadvantages of the

### PRIOR ART

In one aspect, the present disclosure provides an optical lens group which includes, sequentially from an object side to an image side along an optical axis, a first lens, a second lens, a third lens and a fourth lens having refractive power. An object-side surface of the first lens is a convex surface, and an image-side surface of the first lens is a concave surface; the fourth lens has a positive refractive power, an object-side surface of the fourth lens is a convex surface, and an image-side surface of the fourth lens is a concave surface, and at least one of the object-side surface and the image-side surface of the fourth lens has a inflection point. The optical lens group further includes a stop disposed between the first lens and the second lens.

In one embodiment, a radius of curvature R4 of an image-side surface of the second lens and a radius of curvature R3 of an object-side surface of the second lens may satisfy 0.50<R4/R3<2.00.

In one embodiment, a total effective focal length f of the optical lens group and an entrance pupil diameter EPD of the optical lens group may satisfy f/EPD<1.30.

In one embodiment, a distance TTL along the optical axis from the object-side surface of the first lens to an imaging plane of the optical lens group and half of a diagonal length ImgH of an effective pixel area of the electronic photosensitive element on the imaging plane of the optical lens group may satisfy TTL/ImgH<2.10.

In one embodiment, a radius of curvature R7 of the object-side surface of the fourth lens and a radius of curvature R8 of the image-side surface of the fourth lens may satisfy 6.00<(R7*10)/R8<9.00.

In one embodiment, an effective focal length f4 of the fourth lens and a radius of curvature R7 of the object-side surface of the fourth lens may satisfy 3.00<f4/R7<6.00.

In one embodiment, an effective focal length f4 of the fourth lens and a total effective focal length f of the optical lens group may satisfy 0.50<f4/f<2.00.

In one embodiment, a center thickness CT3 of the third lens along the optical axis and a center thickness CT4 of the fourth lens along the optical axis may satisfy 0.50<CT3/CT4<2.00.

In one embodiment, a center thickness CT1 of the first lens along the optical axis and a spaced interval T12 between the first lens and the second lens along the optical axis may satisfy 1.00<CT1/T12<3.50.

In one embodiment, a spaced interval T23 between the second lens and the third lens along the optical axis and a distance TTL along the optical axis from the object-side surface of the first lens to an imaging plane of the optical lens group satisfy 0.50<(T23*10)/TTL<1.50.

In one embodiment, a spaced interval T34 between the third lens and the fourth lens along the optical axis and a spaced interval T12 between the first lens and the second lens along the optical axis may satisfy 1.00<T12/T34<3.50.

In one embodiment, an axial distance SAG21 from an intersection of an object-side surface of the second lens and the optical axis to an apex of an effective radius of the object-side surface of the second lens and an axial distance SAG22 from an intersection of an image-side surface of the second lens and the optical axis to an apex of an effective radius of the image-side surface of the second lens may satisfy 0.30<SAG21/SAG22<1.50.

In one embodiment, a sum of spaced intervals ΣAT along the optical axis between adjacent lenses of the first lens to the fourth lens and a distance TD along the optical axis from the object-side surface of the first lens to the image-side surface of the fourth lens may satisfy ΣAT/TD<0.35.

The present disclosure employs fourth lenses, and the optical lens group has at least one advantageous effect such as miniaturization, high imaging quality, large aperture, and applicable for infrared imaging and the like by rationally assigning the refractive power, the surface shape, the center thickness of each lens, and the on-axis spaced interval between the lenses and the like, and rationally selecting the material of the first lens.

### BRIEF DESCRIPTION OF THE DRAWINGS

Other features, objects, and advantages of the present disclosure will become more apparent from the following detailed description of the non-limiting embodiments with reference to the accompanying drawings. In the accompanying drawings:

FIG. 1 illustrates a schematic structural view of an optical lens group according to Example 1 of the present disclosure;

FIGS. 2A to 2C illustrate a longitudinal aberration curve, an astigmatic curve and a distortion curve of the optical lens group of the Example 1, respectively;

FIG. 3 illustrates a schematic structural view of an optical lens group according to Example 2 of the present disclosure;

FIGS. 4A to 4C illustrate a longitudinal aberration curve, an astigmatic curve and a distortion curve of the optical lens group of the Example 2, respectively;

FIG. 5 illustrates a schematic structural view of an optical lens group according to Example 3 of the present disclosure;

FIGS. 6A to 6C illustrate a longitudinal aberration curve, an astigmatic curve and a distortion curve of the optical lens group of the Example 3, respectively;

FIG. 7 illustrates a schematic structural view of an optical lens group according to Example 4 of the present disclosure;

FIGS. 8A to 8C illustrate a longitudinal aberration curve, an astigmatic curve and a distortion curve of the optical lens group of the Example 4, respectively;

FIG. 9 illustrates a schematic structural view of an optical lens group according to Example 5 of the present disclosure;

FIGS. 10A to 10C illustrate a longitudinal aberration curve, an astigmatic curve and a distortion curve of the optical lens group of the Example 5, respectively;

FIG. 11 illustrates a schematic structural view of an optical lens group according to Example 6 of the present disclosure; and

FIGS. 12A to 12C illustrate a longitudinal aberration curve, an astigmatic curve and a distortion curve of the optical lens group of the Example 6, respectively;

### DETAILED DESCRIPTION OF EMBODIMENTS

For a better understanding of the present disclosure, various aspects of the present disclosure will be described in more detail with reference to the accompanying drawings. It should be understood that the detailed description is merely illustrative of the exemplary embodiments of the present disclosure and is not intended to limit the scope of the present disclosure in any way. Throughout the specification, the same reference numerals refer to the same elements. The expression “and/or” includes any and all combinations of one or more of the associated listed items.

It should be noted that in the present specification, the expressions such as first, second, third are used merely for distinguishing one feature from another, without indicating any limitation on the features. Thus, a first lens discussed below may also be referred to as a second lens or a third lens without departing from the teachings of the present disclosure.

In the accompanying drawings, the thickness, size and shape of the lens have been slightly exaggerated for the convenience of explanation. In particular, shapes of spherical surfaces or aspheric surfaces shown in the accompanying drawings are shown by way of example. That is, shapes of the spherical surfaces or the aspheric surfaces are not limited to the shapes of the spherical surfaces or the aspheric surfaces shown in the accompanying drawings. The accompanying drawings are merely illustrative and not strictly drawn to scale.

Herein, the paraxial area refers to an area near the optical axis. If a surface of a lens is a convex surface and the position of the convex is not defined, it indicates that the surface of the lens is convex at least in the paraxial region; and if a surface of a lens is a concave surface and the position of the concave is not defined, it indicates that the surface of the lens is concave at least in the paraxial region. In each lens, the surface closest to the subject is referred to as an object-side surface of the lens, and the surface closest to the imaging plane is referred to as an image-side surface of the lens.

It should be further understood that the terms “comprising,” “including,” “having,” “containing” and/or “contain,” when used in the specification, specify the presence of stated features, elements and/or components, but do not exclude the presence or addition of one or more other features, elements, components and/or combinations thereof. In addition, expressions, such as “at least one of,” when preceding a list of features, modify the entire list of features rather than an individual element in the list. Further, the use of “may,” when describing embodiments of the present disclosure, refers to “one or more embodiments of the present disclosure.” Also, the term “exemplary” is intended to refer to an example or illustration.

Unless otherwise defined, all terms (including technical and scientific terms) used herein have the same meaning as commonly understood by those of ordinary skill in the art to which the present disclosure belongs. It will be further understood that terms, such as those defined in commonly used dictionaries, should be interpreted as having a meaning that is consistent with the meaning in the context of the relevant art and will not be interpreted in an idealized or overly formal sense, unless expressly so defined herein.

It should also be noted that, the examples in the present disclosure and the features in the examples may be combined with each other on a non-conflict basis. The present disclosure will be described in detail below with reference to the accompanying drawings and in combination with the examples.

The features, principles, and other aspects of the present disclosure are described in detail below.

An optical lens group according to an exemplary embodiment of the present disclosure may include, for example, four lenses having refractive power, i.e. a first lens, a second lens, a third lens and a fourth lens. The four lenses are arranged sequentially from an object side to an image side along an optical axis. Among the first lens to the fourth lens, each two adjacent lenses may have an air gap.

In an exemplary embodiment, the first lens has a positive refractive power or a negative refractive power, an object-side surface of the first lens may be a convex surface, and an image-side surface of the first lens may be a concave surface; the second lens has a positive refractive power or a negative refractive power; the third lens has a positive refractive power or a negative refractive power; and the fourth lens may have a positive refractive power, an object-side surface of the fourth lens may be a convex surface, and an image-side surface of the fourth lens may be a concave surface, and at least one of the object-side surface and the image-side surface of the fourth lens has a inflection point. The fourth lens has a positive refractive power, the object-side surface of the fourth lens is a convex surface, and the image-side surface of the fourth lens is a concave surface, and one or both of the object-side surface and the image-side surface of the fourth lens have at least one inflection point. This setting may correct aberrations generated by the first lens and improve the performance of the optical lens group.

In an exemplary embodiment, the optical lens group described above may include a stop. The stop may be disposed at an appropriate position as required, for example, the stop may be disposed between the first lens and the second lens.

In an exemplary embodiment, an image-side surface of the second lens may be a concave surface.

In an exemplary embodiment, the optical lens group according to the present disclosure may satisfy: 0.50<R4/R3<2.00, where R4 is a radius of curvature of an image-side surface of the second lens and R3 is a radius of curvature of an object-side surface of the second lens. More specifically, R4 and R3 may further satisfy: 0.93<R4/R3≤1.68. By reasonably controlling the ratio between the radius of curvature of the image-side surface of the second lens and the radius of curvature of the object-side surface of the second lens, the astigmatic of the optical lens group may be effectively balanced, the back focal length of the system is shortened, and the miniaturization of the optical lens group is further ensured.

In an exemplary embodiment, the optical lens group according to the present disclosure may satisfy: f/EPD<1.30, where f is a total effective focal length of the optical lens group and EPD is an entrance pupil diameter of the optical lens group. More specifically, f and EPD may further satisfy: 1.156≤f/EPD≤1.296. By reasonably controlling the effective focal length and entrance pupil diameter of the TOF optical lens group, the optical lens group obtains a larger aperture. Enlarging the aperture may improve daylighting, which may reduce noise and improve imaging quality in a relative dark condition.

In an exemplary embodiment, the optical lens group according to the present disclosure may satisfy: TTL/ImgH<2.10, where TTL is a distance along the optical axis from the object-side surface of the first lens to an imaging plane of the optical lens group and ImgH is half of a diagonal length of an effective pixel area of the electronic photosensitive element on the imaging plane of the optical lens group. More specifically, TTL and ImgH may further satisfy: 1.94≤TTL/ImgH≤2.09. Reasonably setting the ratio between the axial distance from the object-side surface of the first lens to the imaging surface and half of the diagonal length of the effective pixel area on the imaging surface ensures the optical lens group have the characteristics of light and thin and meet the requirements on field of view angle of the TOF module.

In an exemplary embodiment, the optical lens group according to the present disclosure may satisfy: 6.00<(R7*10)/R8<9.00, where R7 is a radius of curvature of the object-side surface of the fourth lens and R8 is a radius of curvature of the image-side surface of the fourth lens. More specifically, R7 and R8 may further satisfy: 6.12≤(R7*10)/R8≤8.65. By rationally controlling the ratio between the radius of curvature of the object-side surface of the fourth lens and the radius of curvature of the image-side surface of the fourth lens, the astigmatic of the optical lens group may be effectively balanced, the back focus length of the system is shortened, and the miniaturization of the optical lens group is further ensured.

In an exemplary embodiment, the optical lens group according to the present disclosure may satisfy: 3.00<f4/R7<6.00, where f4 is an effective focal length of the fourth lens and R7 is a radius of curvature of the object-side surface of the fourth lens. More specifically, f4 and R7 may further satisfy: 3.08≤f4/R7≤5.96. Satisfying the conditional expression 3.00<f4/R7<6.00 is conducive to controlling the incident angle of the light on the imaging surface at the off-axis field of view, such that the matching with the photosensitive element and the band-pass optical filter is increased.

In an exemplary embodiment, the optical lens group according to the present disclosure may satisfy: 0.50<f4/f<2.00, where f4 is an effective focal length of the fourth lens and f is a total effective focal length of the optical lens group. More specifically, f4 and f may further satisfy: 0.95≤f4/f≤1.95. Reasonably setting the effective focal length of the fourth lens helps to increase the focal length of the optical lens group, and has the function of adjusting the position of the light, thereby shortening the total length of the optical lens group.

In an exemplary embodiment, the optical lens group according to the present disclosure may satisfy: 0.50<CT3/CT4<2.00, where CT3 is a center thickness of the third lens along the optical axis and CT4 is a center thickness of the fourth lens along the optical axis. More specifically, CT3 and CT4 may further satisfy: 0.89≤CT3/CT4≤1.93. Rationally assigning the center thickness of the third lens and the center thickness of the fourth lens may effectively reduce the size of the rear end of the optical lens group, ensure the miniaturization of the lens assembly, and contribute to the assembly of the optical lens group.

In an exemplary embodiment, the optical lens group according to the present disclosure may satisfy: 1.00<CT1/T12<3.50, where CT1 is a center thickness of the first lens along the optical axis and T12 is a spaced interval between the first lens and the second lens along the optical axis. More specifically, CT1 and T12 may further satisfy: 1.43≤CT1/T12≤3.06. By rationally controlling the ratio of the center thickness of the first lens to the spaced distance between the first lens and the second lens, the chief ray angle of the optical lens group may be adjusted, which may effectively improve the relative brightness of the optical lens group and improve the clarity of the image surface.

In an exemplary embodiment, the optical lens group according to the present disclosure may satisfy: 0.50<(T23*10)/TTL<1.50, where T23 is a spaced interval between the second lens and the third lens along the optical axis and TTL is a distance along the optical axis from the object-side surface of the first lens to an imaging plane of the optical lens group. More specifically, T23 and TTL may further satisfy: 0.59≤(T23*10)/TTL≤1.19. Rationally controlling the ratio of the axial distance from the object-side surface of the first lens to the imaging plane to the spaced interval on the axis between the second lens and the third lens helps to improve the optical lens group's ability to gather light, adjust the light focusing position, shorten the total length of the optical lens group, and ensure the miniaturization of the optical lens group.

In an exemplary embodiment, the optical lens group according to the present disclosure may satisfy: 1.00<T12/T34<3.50, where T12 is a spaced interval between the first lens and the second lens along the optical axis and T34 is a spaced interval between the third lens and the fourth lens along the optical axis. More specifically, T12 and T34 may further satisfy: 1.40≤T34/T12≤3.05. Reasonably assigning the ratio of the spaced interval on the axis between the first lens and the second lens to the spaced interval on the axis between the third lens and the fourth lens helps to improve the stability of the optical lens group lens assembly and the consistency of mass production, which is conducive to improving the production yield of the optical lens group.

In an exemplary embodiment, the optical lens group according to the present disclosure may satisfy: 0.30<SAG21/SAG22<1.50, where SAG21 is an axial distance from an intersection of an object-side surface of the second lens and the optical axis to an apex of an effective radius of the object-side surface of the second lens, and SAG22 is an axial distance from an intersection of an image-side surface of the second lens and the optical axis to an apex of an effective radius of the image-side surface of the second lens. More specifically, SAG21 and SAG22 may further satisfy: 0.38≤SAG21/SAG22≤1.29. By reasonably assigning the ratio of the axial distance from the intersection of the object-side surface of the second lens and the optical axis to the apex of the effective radius of the object-side surface of the second lens to the axial distance from the intersection of the image-side surface of the second lens and the optical axis to the apex of the effective radius of the image-side surface of the second lens, the deflection angle of the chief ray may be controlled reasonably, the degree of matching with the chip is improved, and the structure of the optical lens group is adjusted advantageously.

In an exemplary embodiment, the optical lens group according to the present disclosure may satisfy: ΣAT/TD<0.35, where TD is a distance along the optical axis from the object-side surface of the first lens to the image-side surface of the fourth lens, and ΣAT is a sum of spaced intervals along the optical axis between adjacent lenses of the first lens to the fourth lens. More specifically, ΣAT and TD may further satisfy: 0.26≤ΣAT/TD≤0.32. Reasonably controlling the ratio of the axial distance from the object-side surface of the first lens to the image-side surface of the fourth lens to the sum of the air gaps on the optical axis between adjacent lenses having refractive power of the first lens to the fourth lens helps to reduce the sensitivity of the optical lens group, and to achieve the large aperture and high resolution characteristics of the optical lens group.

Optionally, the above optical lens group may further include an optical filter for correcting the color deviation and/or a protective glass for protecting the photosensitive element on the imaging plane.

The optical lens group according to the above embodiments of the present disclosure may employ a plurality of lenses, such as four lenses as described above. By properly assigning the refractive power of each lens, the surface shape, the center thickness of each lens, and spaced distances on the optical axis between the lenses, the size and the sensitivity of the optical lens group may be effectively reduced, and the workability of the optical lens group may be improved, such that the optical lens group is more advantageous for production processing and may be applied to portable electronic products. In addition, the first lens of the optical lens group of the present disclosure employs a black content material which only allows infrared imaging light to pass through during imaging, thereby greatly avoiding interference of visible light to the chip, and also having the characteristics of large aperture and miniaturization.

In the embodiments of the present disclosure, at least one of the surfaces of each lens is aspheric, that is, at least one of an object-side surface and an image-side surface of each of the first lens, the second lens, the third lens, and the fourth lens may be an aspheric. The aspheric lens is characterized by a continuous change in curvature from the center of the lens to the periphery of the lens. Unlike a spherical lens having a constant curvature from the center of the lens to the periphery of the lens, the aspheric lens has a better curvature radius characteristic, and has the advantages of improving distortion aberration and improving astigmatic aberration. By using an aspheric lens, the aberrations that occur during imaging may be eliminated as much as possible, and thus improving the image quality. Optionally, the object-side surface and the image-side surface of each of the first lens, the second lens, the third lens, and the fourth lens are aspheric.

However, it will be understood by those skilled in the art that the number of lenses constituting the optical lens group may be varied to achieve the various results and advantages described in this specification without departing from the technical solution claimed by the present disclosure. For example, although the embodiment is described by taking four lenses as an example, the optical lens group is not limited to include four lenses. The optical lens group may also include other numbers of lenses if desired.

Some specific examples of an optical lens group applicable to the above embodiment will be further described below with reference to the accompanying drawings.

### Example 1

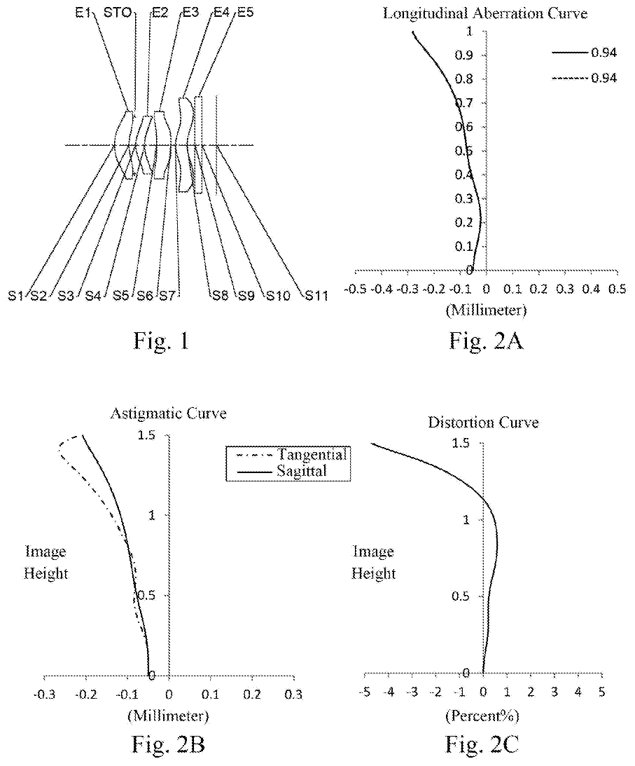

An optical lens group according to example 1 of the present disclosure is described below with reference to FIG. 1 to FIG. 2C. FIG. 1 shows a schematic structural view of the optical lens group according to example 1 of the present disclosure.

As shown in FIG. 1, the optical lens group includes a first lens E1, a stop STO, a second lens E2, a third lens E3, a fourth lens E4, an optical filter E5 and an imaging plane S11, which are sequentially arranged from an object side to an image side along an optical axis.

The first lens E1 has a positive refractive power. An object-side surface S1 of the first lens E1 is a convex surface, and an image-side surface S2 of the first lens E1 is a concave surface. The second lens E2 has a positive refractive power. An object-side surface S3 of the second lens E2 is a convex surface, and an image-side surface S4 of the second lens E2 is a concave surface. The third lens E3 has a negative refractive power. An object-side surface S5 of the third lens E3 is a concave surface, and an image-side surface S6 of the third lens E3 is a concave surface. The fourth lens E4 has a positive refractive power. An object-side surface S7 of the fourth lens E4 is a convex surface, and an image-side surface S8 of the fourth lens E4 is a concave surface. The optical filter E5 has an object-side surface S9 and an image-side surface S10. Light from an object sequentially passes through the respective surfaces S1 to S10 and is finally imaged on the imaging plane S11.

Table 1 shows a basic parameter table of the optical lens group in example 1, wherein the units for the radius of curvature, the thickness and the focal length are millimeter (mm).

TABLE 1
Example 1: f = 2.10 mm, ImgH = 1.50 mm, Semi-FOV = 36.1°

| | | | | Material | | | |
|---|---|---|---|---|---|---|---|
| Surface | Surface | Radius of | | Refractive | Abbe | Focal | Conic |
| number | type | curvature | Thickness | index | number | length | coefficient |
| OBJ | spherical | infinite | 800.0000 | | | | |
| S1 | aspheric | 1.2081 | 0.4386 | 1.57 | 30.19 | 11.53 | −0.8456 |
| S2 | aspheric | 1.2884 | 0.1716 | | | | −6.2969 |
| STO | spherical | infinite | 0.0300 | | | | |
| S3 | aspheric | 0.9121 | 0.2723 | 1.62 | 23.53 | 3.84 | −0.6584 |
| S4 | aspheric | 1.3134 | 0.3658 | | | | 1.1561 |
| S5 | aspheric | −8.4146 | 0.4228 | 1.53 | 56.07 | −5.79 | 0.0000 |
| S6 | aspheric | 4.8518 | 0.1349 | | | | −56.8450 |
| S7 | aspheric | 0.6565 | 0.3535 | 1.62 | 23.53 | 2.26 | −5.6882 |
| S8 | aspheric | 0.9863 | 0.2420 | | | | −1.2041 |
| S9 | spherical | infinite | 0.2100 | 1.51 | 64.17 | | |
| S10 | spherical | infinite | 0.4400 | | | | |
| S11 | spherical | infinite | | | | | |

Where, f is a total effective focal length of the optical lens group, ImgH is half of a diagonal length of an effective pixel area of the electronic photosensitive element on the imaging plane, and Semi-FOV is half of a maximal field-of-view of the optical lens group.

In example 1, the object-side surface and the image-side surface of any one of the first lens E1 to the fourth lens E4 are aspheric. The surface shape x of each aspheric lens may be defined by using, but not limited to, the following aspheric formula.

$$x = \frac{{ch}^{2}}{1 + \sqrt{1 - ( k + 1 ) {c}^{2} {h}^{2}}} + Σ {Aih}^{i} \qquad ( 1 )$$

Where, x is the sag—the axis-component of the displacement of the surface from the aspheric vertex, when the surface is at height h from the optical axis; c is a paraxial curvature of the aspheric surface, c=1/R (that is, the paraxial curvature c is reciprocal of the radius of curvature R in the above Table 1); k is a conic coefficient; A1 is a correction coefficient for the i-th order of the aspheric surface. Table 2 below shows high-order coefficients A4, A6, A8, A10, A12, A14, A16, A18 and A20 applicable to each aspheric surface S1-S8 in example 1.

TABLE 2

| Sur- | | | | | | | | | |
|---|---|---|---|---|---|---|---|---|---|
| face | | | | | | | | | |
| num- | | | | | | | | | |
| ber | A4 | A6 | A8 | A10 | Al2 | A14 | A16 | A18 | A20 |
| S1 | −7.2742E−02 | 4.6778E−01 | −1.9776E+00 | 4.3202E+00 | −4.4207E+00 | −3.7835E−02 | 4.2744E+00 | −3.6299E+00 | 9.9205E−01 |
| S2 | −2.1437E−02 | −1.5387E−01 | −1.0176E+00 | 5.5430E+00 | −1.4906E+01 | 2.3109E+01 | −2.0380E+01 | 9.3236E+00 | −1.6657E+00 |
| S3 | −4.0564E−01 | 4.4481E+00 | −3.8648E+01 | 1.8254E+02 | −5.3951E+02 | 9.8445E+02 | −1.0670E+03 | 6.2877E+02 | −1.5496E+02 |
| S4 | 1.0383E−01 | −2.6805E−01 | −2.3302E+00 | 1.0581E+01 | −5.0149E+01 | 1.3344E+02 | −1.7692E+02 | 1.1476E+02 | −3.0565E+01 |
| S5 | 0.0000E+00 | 0.0000E+00 | 0.0000E+00 | 0.0000E+00 | 0.0000E+00 | 0.0000E+00 | 0.0000E+00 | 0.0000E+00 | 0.0000E+00 |
| S6 | −2.7276E+00 | 1.4241E+01 | −6.0622E+01 | 1.8377E+02 | −3.7151E+02 | 4.8120E+02 | −3.7760E+02 | 1.6196E+02 | −2.8999E+01 |
| S7 | 5.3318E−02 | −1.4913E+00 | 3.1946E+00 | −3.6116E+00 | 2.4910E+00 | −1.0603E+00 | 2.6860E−01 | −3.6836E−02 | 2.0921E−03 |
| S8 | 4.2052E−02 | −1.9489E+00 | 5.4222E+30 | −8.4089E+00 | 8.2899E+00 | −5.2623E+00 | 2.0722E+00 | −4.5866E−01 | 4.3484E−02 |

FIG. 2A illustrates a longitudinal aberration curve of the optical lens group according to example 1, representing deviations of focal points converged by light of different wavelengths after passing through the optical lens group. FIG. 2B illustrates an astigmatic curve of the optical lens group according to example 1, representing a curvature of a tangential plane and a curvature of a sagittal plane. FIG. 2C illustrates a distortion curve of the optical lens group according to example 1, representing amounts of distortion at different FOVs. It can be seen from FIG. 2A to FIG. 2C that the optical lens group provided in example 1 may achieve good image quality.

### Example 2

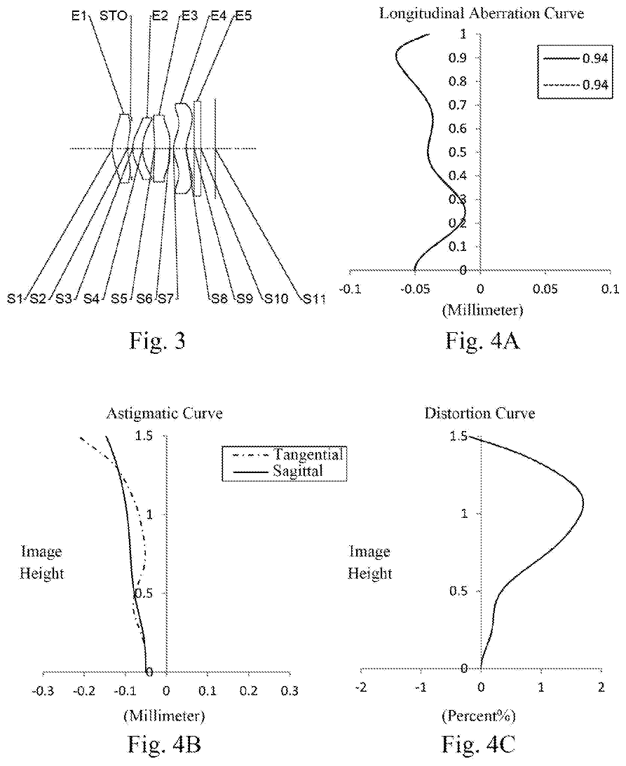

An optical lens group according to example 2 of the present disclosure is described below with reference to FIG. 3 to FIG. 4C. In this example and the following examples, for the purpose of brevity, the description of parts similar to those in example 1 will be omitted. FIG. 3 is a schematic structural view of the optical lens group according to example 2 of the present disclosure.

As shown in FIG. 3, the optical lens group includes a first lens E1, a stop STO, a second lens E2, a third lens E3, a fourth lens E4, an optical filter E5 and an imaging plane S1, which are sequentially arranged from an object side to an image side along an optical axis.

The first lens E1 has a negative refractive power. An object-side surface S1 of the first lens E1 is a convex surface, and an image-side surface S2 of the first lens E1 is a concave surface. The second lens E2 has a positive refractive power. An object-side surface S3 of the second lens E2 is a convex surface, and an image-side surface S4 of the second lens E2 is a concave surface. The third lens E3 has a negative refractive power. An object-side surface S5 of the third lens E3 is a concave surface, and an image-side surface S6 of the third lens E3 is a concave surface. The fourth lens E4 has a positive refractive power. An object-side surface S7 of the fourth lens E4 is a convex surface, and an image-side surface S8 of the fourth lens E4 is a concave surface. The optical filter E5 has an object-side surface S9 and an image-side surface S10. Light from an object sequentially passes through the respective surfaces S1 to S10 and is finally imaged on the imaging plane S11.

Table 3 shows a basic parameter table of the optical lens group in example 2, wherein the units for the radius of curvature, the thickness and the focal length are millimeter (mm). Table 4 shows high-order coefficients applicable to each aspheric surface in example 2, wherein the surface shape of each aspheric surface may be defined by the formula (1) given in the above example 1.

TABLE 3
Example 2: f = 2.08 mm, ImgH = 1.50 mm, Semi-FOV = 35.1°

| | | | | Material | | | |
|---|---|---|---|---|---|---|---|
| Surface | Surface | | | Refractive | Abbe | Focal | Conic |
| number | type | Radius of curvature | Thickness | index | number | length | coefficient |
| OBJ | spherical | infinite | 800.0000 | | | | |
| S1 | aspheric | 1.3982 | 0.4648 | 1.57 | 30.19 | −497.25 | −1.1836 |
| S2 | aspheric | 1.2242 | 0.1221 | | | | −10.7589 |
| STO | spherical | infinite | 0.0300 | | | | |
| S3 | aspheric | 0.8156 | 0.3018 | 1.62 | 23.53 | 2.70 | −0.7288 |
| S4 | aspheric | 1.3718 | 0.3698 | | | | 1.2563 |
| S5 | aspheric | −8.5748 | 0.4617 | 1.53 | 56.07 | −4.16 | 0.0000 |
| S6 | aspheric | 2.9938 | 0.1152 | | | | −99.0000 |
| S7 | aspheric | 0.6465 | 0.3827 | 1.62 | 23.53 | 1.99 | −5.5356 |
| S8 | aspheric | 1.0566 | 0.2412 | | | | −1.1294 |
| S9 | spherical | infinite | 0.2100 | 1.51 | 64.17 | | |
| S10 | spherical | infinite | 0.4354 | | | | |
| S11 | spherical | infinite | | | | | |

TABLE 4

| Sur- | | | | | | | | | |
|---|---|---|---|---|---|---|---|---|---|
| face | | | | | | | | | |
| num- | | | | | | | | | |
| ber | A4 | A6 | A8 | A10 | Al2 | A14 | A16 | A18 | A20 |
| S1 | −9.5332E−02 | −1.2259E−01 | 2.1302E+00 | −1.0549E+01 | 2.7225E+01 | −4.1083E+01 | 3.6046E+01 | −1.6982E+01 | 3.3134E+00 |
| S2 | −6.6842E−02 | −8.9408E−01 | 3.9218E+00 | −1.4732E+01 | 3.8792E+01 | −6.4571E+01 | 6.4691E+01 | −3.5582E+01 | 8.2383E+00 |
| S3 | −6.6839E−01 | 5.8702E+00 | −4.2332E+01 | 1.7610E+02 | −4.6606E+02 | 7.7859E+02 | −7.8595E+02 | 4.3565E+02 | −1.0151E+02 |
| S4 | 1.4076E−01 | 1.0245E+00 | −1.4348E+01 | 7.3891E+01 | −2.5351E+02 | 5.4631E+02 | −6.9112E+02 | 4.6850E+02 | −1.3213E+02 |
| S5 | 0.0000E+00 | 0.0000E+00 | 0.0000E+00 | 0.0000E+00 | 0.0000E+00 | 0.0000E+00 | 0.0000E+00 | 0.0000E+00 | 0.0000E+00 |
| S6 | −2.4299E+00 | 1.1674E+01 | −4.4562E+01 | 1.2202E+02 | −2.2466E+02 | 2.6699E+02 | −1.9306E+02 | 7.6432E+01 | −1.2632E+01 |
| S7 | 4.7576E−02 | −1.5149E+00 | 3.2751E+00 | −3.8818E+00 | 2.8090E+00 | −1.2356E+00 | 3.1881E−01 | −4.4088E−02 | 2.5083E−03 |
| S8 | 1.0018E−01 | −2.3169E+00 | 5.9405E+00 | −8.8187E+00 | 8.3856E+00 | −5.1590E+00 | 1.9809E+00 | −4.3085E−01 | 4.0506E−02 |

FIG. 4A illustrates a longitudinal aberration curve of the optical lens group according to example 2, representing deviations of focal points converged by light of different wavelengths after passing through the optical lens group. FIG. 4B illustrates an astigmatic curve of the optical lens group according to example 2, representing a curvature of a tangential plane and a curvature of a sagittal plane. FIG. 4C illustrates a distortion curve of the optical lens group according to example 2, representing amounts of distortion at different FOVs It can be seen from FIG. 4A to FIG. 4C that the optical lens group provided in example 2 may achieve good image quality.

### Example 3

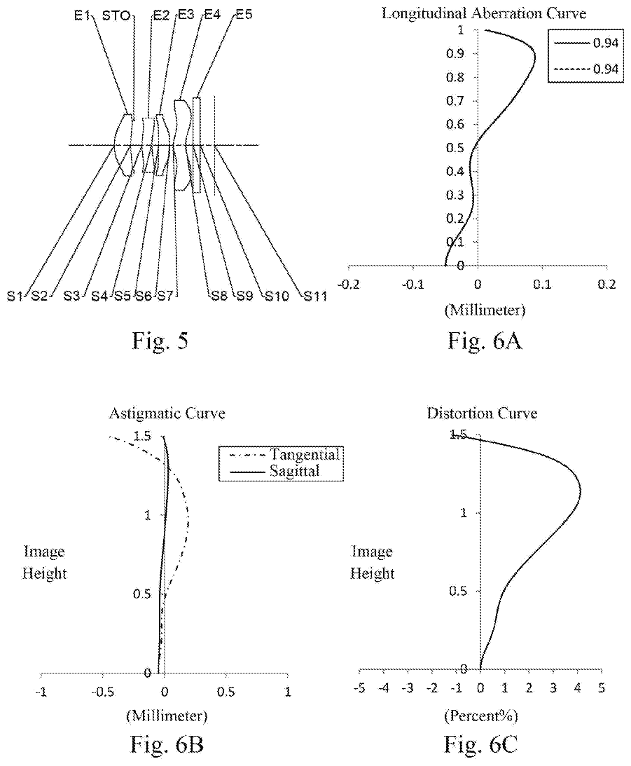

An optical lens group according to example 3 of the present disclosure is described below with reference to FIG. 5 to FIG. 6C. FIG. 5 is a schematic structural view of the optical lens group according to example 3 of the present disclosure.

As shown in FIG. 5, the optical lens group includes a first lens E1, a stop STO, a second lens E2, a third lens E3, a fourth lens E4, an optical filter E5 and an imaging plane S11, which are sequentially arranged from an object side to an image side along an optical axis.

The first lens E1 has a positive refractive power. An object-side surface S1 of the first lens E1 is a convex surface, and an image-side surface S2 of the first lens E1 is a concave surface. The second lens E2 has a negative refractive power. An object-side surface S3 of the second lens E2 is a convex surface, and an image-side surface S4 of the second lens E2 is a concave surface. The third lens E3 has a negative refractive power. An object-side surface S5 of the third lens E3 is a concave surface, and an image-side surface S6 of the third lens E3 is a concave surface. The fourth lens E4 has a positive refractive power. An object-side surface S7 of the fourth lens E4 is a convex surface, and an image-side surface S8 of the fourth lens E4 is a concave surface. The optical filter E5 has an object-side surface S9 and an image-side surface S10. Light from an object sequentially passes through the respective surfaces S1 to S10 and is finally imaged on the imaging plane S11.

Table 5 shows a basic parameter table of the optical lens group in example 3, wherein the units for the radius of curvature, the thickness and the focal length are millimeter (mm). Table 6 shows high-order coefficients applicable to each aspheric surface in example 3, wherein the surface shape of each aspheric surface may be defined by the formula (1) given in the above example 1.

TABLE 5
Example 3: f = 2.10 mm, ImgH = 1.50 mm, Semi-FOV = 35.0°

| | | | | Material | | | |
|---|---|---|---|---|---|---|---|
| Surface | Surface | | | Refractive | Abbe | Focal | Conic |
| number | type | Radius of curvature | Thickness | index | number | length | coefficient |
| OBJ | spherical | infinite | 800.0000 | | | | |
| S1 | aspheric | 1.2147 | 0.4881 | 1.57 | 30.19 | 3.66 | −0.9820 |
| S2 | aspheric | 2.5120 | 0.0965 | | | | −8.2607 |
| STO | spherical | infinite | 0.2438 | | | | |
| S3 | aspheric | 1.6960 | 0.2885 | 1.62 | 23.53 | −384.00 | −0.1269 |
| S4 | aspheric | 1.5746 | 0.2090 | | | | 1.7254 |
| S5 | aspheric | −8.5030 | 0.3243 | 1.53 | 56.07 | −7.34 | 0.0000 |
| S6 | aspheric | 7.1697 | 0.1115 | | | | −60.3521 |
| S7 | aspheric | 0.5930 | 0.3633 | 1.62 | 23.53 | 2.33 | −6.3046 |
| S8 | aspheric | 0.7724 | 0.2284 | | | | −1.4690 |
| S9 | spherical | infinite | 0.2121 | 1.51 | 64.17 | | |
| S10 | spherical | infinite | 0.4315 | | | | |
| S11 | spherical | infinite | | | | | |

TABLE 6

| Sur- | | | | | | | | | |
|---|---|---|---|---|---|---|---|---|---|
| face | | | | | | | | | |
| num- | | | | | | | | | |
| ber | A4 | A6 | A8 | A10 | A12 | A14 | A16 | A18 | A20 |
| S1 | −1.2762E−01 | 1.9254E+00 | −1.3334E+01 | 5.1538E+01 | −1.2000E+02 | 1.7023E+02 | −1.4391E+02 | 6.6174E+01 | −1.2639E+01 |
| S2 | −1.8233E−02 | −1.2449E+00 | 7.7913E+00 | −2.9240E+01 | 6.3322E+01 | −8.0701E+01 | 5.8330E+01 | −2.1108E+01 | 2.6855E+00 |
| S3 | −3.4917E−01 | −2.1039E−02 | −3.4588E+00 | 1.1790E+01 | −1.6049E+01 | 8.5422E−01 | 3.2744E+01 | −4.1812E+01 | 1.6016E+01 |
| S4 | −2.1914E−01 | 4.4504E−01 | −8.1640E+00 | 3.7738E+01 | −1.1849E+02 | 2.5767E+02 | −3.6247E+02 | 2.9380E+02 | −1.0190E+02 |
| S5 | 0.0000E+00 | 0.0000E+00 | 0.0000E+00 | 0.0000E+00 | 0.0000E+00 | 0.0000E+00 | 0.0000E+00 | 0.0000E+00 | 0.0000E+00 |
| S6 | −4.0347E+00 | 2.5268E+01 | −1.1306E+02 | 3.4974E+02 | −7.1882E+02 | 9.4598E+02 | −7.5463E+02 | 3.2932E+02 | −6.0029E+01 |
| S7 | −5.5104E−01 | 3.8936E−02 | 1.3230E+00 | −2.8239E+00 | 3.0314E+00 | −1.7865E+00 | 5.7233E−01 | −9.2189E−02 | 5.7330E−03 |
| S8 | −7.8627E−01 | 9.6961E−02 | 2.5805E+00 | −6.6671E+00 | 8.8052E+00 | −6.9380E+00 | 3.2612E+00 | −8.4058E−01 | 9.1168E−02 |

FIG. 6A illustrates a longitudinal aberration curve of the optical lens group according to example 3, representing deviations of focal points converged by light of different wavelengths after passing through the optical lens group. FIG. 6B illustrates an astigmatic curve of the optical lens group according to example 3, representing a curvature of a tangential plane and a curvature of a sagittal plane. FIG. 6C illustrates a distortion curve of the optical lens group according to example 3, representing amounts of distortion at different FOVs. It can be seen from FIG. 6A to FIG. 6C that the optical lens group provided in example 3 may achieve good image quality.

### Example 4

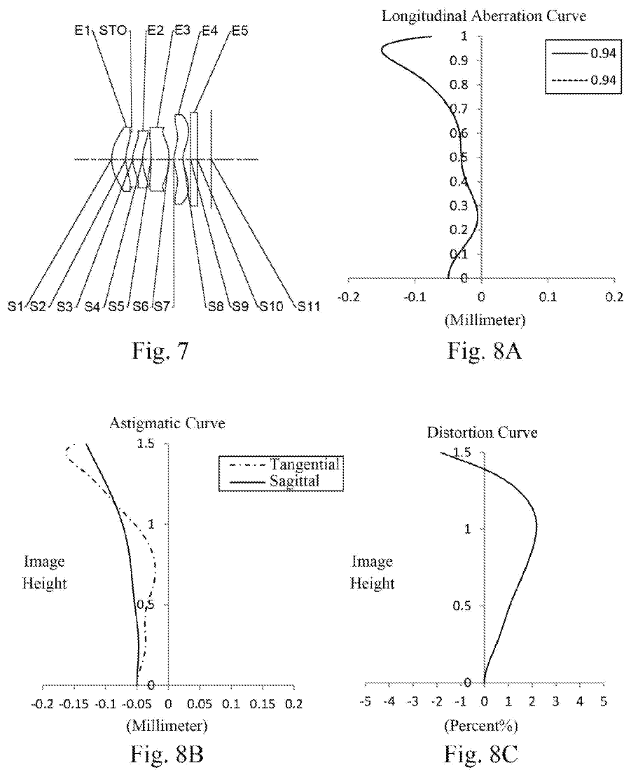

An optical lens group according to example 4 of the present disclosure is described below with reference to FIG. 7 to FIG. 8C. FIG. 7 is a schematic structural view of the optical lens group according to example 4 of the present disclosure.

As shown in FIG. 7, the optical lens group includes a first lens E1, a stop STO, a second lens E2, a third lens E3, a fourth lens E4, an optical filter E5 and an imaging plane S11, which are sequentially arranged from an object side to an image side along an optical axis.

The first lens E1 has a positive refractive power. An object-side surface S1 of the first lens E1 is a convex surface, and an image-side surface S2 of the first lens E1 is a concave surface. The second lens E2 has a positive refractive power. An object-side surface S3 of the second lens E2 is a convex surface, and an image-side surface S4 of the second lens E2 is a concave surface. The third lens E3 has a positive refractive power. An object-side surface S5 of the third lens E3 is a concave surface, and an image-side surface S6 of the third lens E3 is a convex surface. The fourth lens E4 has a positive refractive power. An object-side surface S7 of the fourth lens E4 is a convex surface, and an image-side surface S8 of the fourth lens E4 is a concave surface. The optical filter E5 has an object-side surface S9 and an image-side surface S10. Light from an object sequentially passes through the respective surfaces S1 to S10 and is finally imaged on the imaging plane S11.

Table 7 shows a basic parameter table of the optical lens group in example 4, wherein the units for the radius of curvature, the thickness and the focal length are millimeter (mm). Table 8 shows high-order coefficients applicable to each aspheric surface in example 4, wherein the surface shape of each aspheric surface may be defined by the formula (1) given in the above example 1.

TABLE 7
Example 4: f = 2.10 mm, ImgH = 1.50 mm, Semi-FOV = 35.3°

| | | | | Material | | | |
|---|---|---|---|---|---|---|---|
| Surface | Surface | | | Refractive | Abbe | Focal | Conic |
| number | type | Radius of curvature | Thickness | index | number | length | coefficient |
| OBJ | spherical | infinite | 800.0000 | | | | |
| S1 | aspheric | 1.1808 | 0.4420 | 1.57 | 30.19 | 9.73 | −0.7648 |
| S2 | aspheric | 1.3002 | 0.1821 | | | | −5.9555 |
| STO | spherical | infinite | 0.0300 | | | | |
| S3 | aspheric | 0.9817 | 0.3063 | 1.62 | 23.53 | 4.05 | −0.7775 |
| S4 | aspheric | 1.4244 | 0.2621 | | | | 1.0701 |
| S5 | aspheric | −8.7044 | 0.5499 | 1.53 | 56.07 | 500.39 | 0.0000 |
| S6 | aspheric | −8.6091 | 0.1514 | | | | −96.6480 |
| S7 | aspheric | 0.6885 | 0.2850 | 1.62 | 23.53 | 4.10 | −6.3796 |
| S8 | aspheric | 0.7961 | 0.2337 | | | | −1.7233 |
| S9 | spherical | infinite | 0.2100 | 1.51 | 64.17 | | |
| S10 | spherical | infinite | 0.4340 | | | | |
| S11 | spherical | infinite | | | | | |

TABLE 8

| Sur- | | | | | | | | | |
|---|---|---|---|---|---|---|---|---|---|
| face | | | | | | | | | |
| num- | | | | | | | | | |
| ber | A4 | A6 | A8 | A10 | Al2 | A14 | A16 | A18 | A20 |
| S1 | −7.1153E−02 | 4.5281E−01 | −1.3393E+00 | 2.3331E−01 | 8.2852E+00 | −2.2082E+01 | 2.6107E+01 | −1.5163E+01 | 3.5017E+00 |
| S2 | 3.5447E−02 | −5.0529E−01 | 1.6217E+00 | −6.2535E+00 | 1.6544E+01 | −2.8116E+01 | 2.9392E+01 | −1.7088E+01 | 4.2028E+00 |
| S3 | −4.3312E−01 | 5.0298E+00 | −4.5503E+01 | 2.2244E+02 | −6.7389E+02 | 1.2562E+03 | −1.3921E+03 | 8.4011E+02 | −2.1246E+02 |
| S4 | −1.7919E−03 | 1.4131E+00 | −1.9999E+01 | 1.1000E+02 | −3.7467E+02 | 7.6228E+02 | −8.8056E+02 | 5.3030E+02 | −1.2933E+02 |
| S5 | 0.0000E+00 | 0.0000E+00 | 0.0000E+00 | 0.0000E+00 | 0.0000E+00 | 0.0000E+00 | 0.0000E+00 | 0.0000E+00 | 0.0000E+00 |
| S6 | −2.1356E+00 | 1.1600E+01 | −5.0413E+01 | 1.5648E+02 | −3.2498E+02 | 4.3440E+02 | −3.5269E+02 | 1.5677E+02 | −2.9131E+01 |
| S7 | −1.1212E−01 | −1.5846E+00 | 4.3359E+00 | −5.9202E+00 | 4.8039E+00 | −2.3438E+00 | 6.6588E−01 | −1.0067E−01 | 6.2120E−03 |
| S8 | −5.1188E−01 | −6.5126E−01 | 3.5907E+00 | −7.0202E+00 | 8.0174E+00 | −5.7117E+00 | 2.4814E+00 | −5.9857E−01 | 6.1233E−02 |

FIG. 8A illustrates a longitudinal aberration curve of the optical lens group according to example 4, representing deviations of focal points converged by light of different wavelengths after passing through the optical lens group. FIG. 8B illustrates an astigmatic curve of the optical lens group according to example 4, representing a curvature of a tangential plane and a curvature of a sagittal plane. FIG. 8C illustrates a distortion curve of the optical lens group according to example 4, representing amounts of distortion at different FOVs. It can be seen from FIG. 8A to FIG. 8C that the optical lens group provided in example 4 may achieve good image quality.

### Example 5

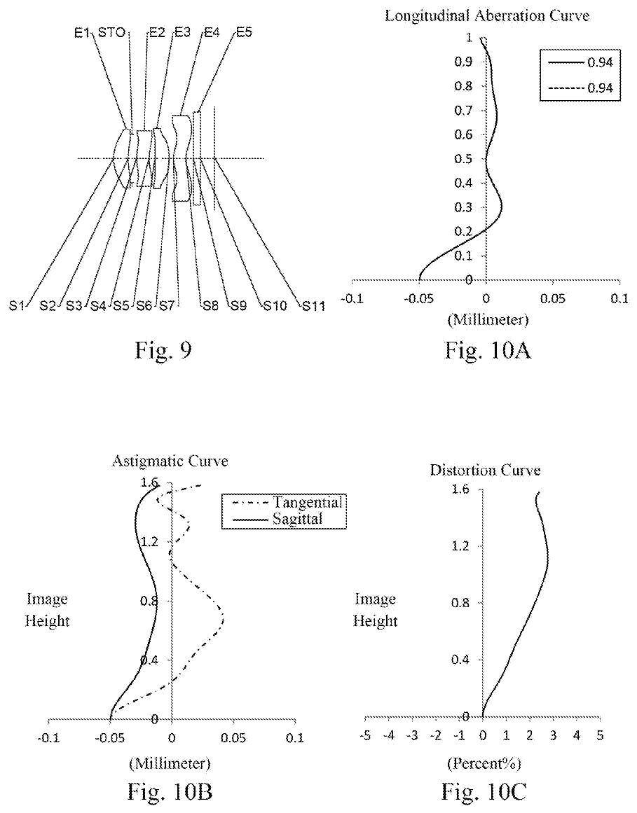

An optical lens group according to example 5 of the present disclosure is described below with reference to FIG. 9 to FIG. 10C. FIG. 9 is a schematic structural view of the optical lens group according to example 5 of the present disclosure.

As shown in FIG. 9, the optical lens group includes a first lens E1, a stop STO, a second lens E2, a third lens E3, a fourth lens E4, an optical filter E5 and an imaging plane S11, which are sequentially arranged from an object side to an image side along an optical axis.

The first lens E1 has a positive refractive power. An object-side surface S1 of the first lens E1 is a convex surface, and an image-side surface S2 of the first lens E1 is a concave surface. The second lens E2 has a positive refractive power. An object-side surface S3 of the second lens E2 is a convex surface, and an image-side surface S4 of the second lens E2 is a concave surface. The third lens E3 has a negative refractive power. An object-side surface S5 of the third lens E3 is a convex surface, and an image-side surface S6 of the third lens E3 is a concave surface. The fourth lens E4 has a positive refractive power. An object-side surface S7 of the fourth lens E4 is a convex surface, and an image-side surface S8 of the fourth lens E4 is a concave surface. The optical filter E5 has an object-side surface S9 and an image-side surface S1. Light from an object sequentially passes through the respective surfaces S1 to S510 and is finally imaged on the imaging plane S11.

Table 9 shows a basic parameter table of the optical lens group in example 5, wherein the units for the radius of curvature, the thickness and the focal length are millimeter (mm). Table 10 shows high-order coefficients applicable to each aspheric surface in example 5, wherein the surface shape of each aspheric surface may be defined by the formula (1) given in the above example 1.

TABLE 9
Example 5: f = 2.10 mm, ImgH = 1.58 mm, Semi-FOV = 35.5°

| | | | | | Material | | |
|---|---|---|---|---|---|---|---|
| Surface | Surface | Radius of | | Refractive | Abbe | Focal | Conic |
| number | type | curvature | Thickness | index | number | length | coefficient |
| OBJ | spherical | infinite | 800.0000 | | | | |
| S1 | aspheric | 1.2098 | 0.4465 | 1.57 | 30.19 | 4.67 | -0.8572 |
| S2 | aspheric | 1.9350 | 0.1189 | | | | -7.7360 |
| STO | spherical | infinite | 0.1411 | | | | |
| S3 | aspheric | 1.5510 | 0.3802 | 1.62 | 23.53 | 112.88 | -2.5385 |
| S4 | aspheric | 1.4379 | 0.1826 | | | | 0.8322 |
| S5 | aspheric | 412.8926 | 0.4361 | 1.53 | 56.07 | -100.77 | -99.0000 |
| S6 | aspheric | 46.9495 | 0.1304 | | | | -74.8570 |
| S7 | aspheric | 0.6288 | 0.3816 | 1.62 | 23.53 | 2.79 | -6.1255 |
| S8 | aspheric | 0.7607 | 0.2317 | | | | -1.2674 |
| S9 | spherical | infinite | 0.2121 | 1.51 | 64.17 | | |
| S10 | spherical | infinite | 0.4364 | | | | |
| S11 | spherical | infinite | | | | | |

TABLE 10

| Sur- | | | | | | | | | |
|---|---|---|---|---|---|---|---|---|---|
| face | | | | | | | | | |
| num- | | | | | | | | | |
| ber | A4 | A6 | A8 | A10 | Al2 | A14 | A16 | A18 | A20 |
| S1 | −1.3695E−01 | 1.9535E+00 | −1.3575E+01 | 5.3496E+01 | −1.2639E+02 | 1.8130E+02 | −1.5374E+02 | 6.9911E+01 | −1.2947E+01 |
| S2 | −3.0570E−02 | −1.3577E+00 | 9.3719E+00 | −3.7557E+01 | 8.8491E+01 | −1.2530E+02 | 1.0283E+02 | −4.3945E+01 | 7.3256E+00 |
| S3 | −3.6765E−01 | 3.4830E−01 | −4.9389E+00 | 1.5491E+01 | −1.8852E+01 | −9.3519E+00 | 5.4787E+01 | −5.6243E+01 | 1.8804E+01 |
| S4 | −3.0154E−01 | 1.5359E+00 | −1.6514E+01 | 7.6705E+01 | −2.1528E+02 | 3.7464E+02 | −3.9625E+02 | 2.3572E+02 | −6.0733E+01 |
| S5 | −3.8362E−01 | 6.0802E+00 | −4.2919E+01 | 1.7502E+02 | −4.3999E+02 | 6.6948E+02 | −5.9318E+02 | 2.8050E+02 | −5.4668E+01 |
| S6 | −3.3758E+00 | 1.8661E+01 | −7.6580E+01 | 2.1951E+02 | −4.2025E+02 | 5.1527E+02 | −3.8145E+02 | 1.5374E+02 | −2.5777E+01 |
| S7 | −6.2737E−01 | 1.7285E−01 | 1.1002E+00 | −2.4871E+00 | 2.6075E+00 | −1.4801E+00 | 4.5685E−01 | −7.1163E−02 | 4.3022E−03 |
| S8 | −9.0908E−01 | 5.0034E−01 | 1.4376E+00 | −4.3984E+00 | 5.9163E+00 | −4.6301E+00 | 2.1551E+00 | −5.5273E−01 | 6.0135E−02 |

FIG. 10A illustrates a longitudinal aberration curve of the optical lens group according to example 5, representing deviations of focal points converged by light of different wavelengths after passing through the optical lens group. FIG. 10B illustrates an astigmatic curve of the optical lens group according to example 5, representing a curvature of a tangential plane and a curvature of a sagittal plane. FIG. 10C illustrates a distortion curve of the optical lens group according to example 5, representing amounts of distortion at different FOVs. It can be seen from FIG. 10A to FIG. 10C that the optical lens group provided in example 5 may achieve good image quality.

### Example 6

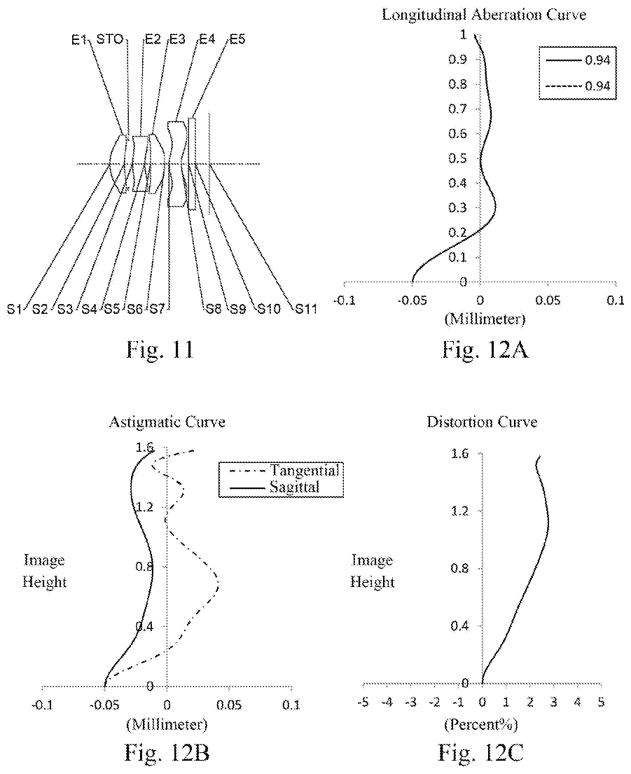

An optical lens group according to example 6 of the present disclosure is described below with reference to FIG. 11 to FIG. 12C. FIG. 11 is a schematic structural view of the optical lens group according to example 6 of the present disclosure.

As shown in FIG. 11, the optical lens group includes a first lens E1, a stop STO, a second lens E2, a third lens E3, a fourth lens E4, an optical filter E5 and an imaging plane S11, which are sequentially arranged from an object side to an image side along an optical axis.

The first lens E1 has a positive refractive power. An object-side surface S1 of the first lens E1 is a convex surface, and an image-side surface S2 of the first lens E1 is a concave surface. The second lens E2 has a positive refractive power. An object-side surface S3 of the second lens E2 is a convex surface, and an image-side surface S4 of the second lens E2 is a concave surface. The third lens E3 has a negative refractive power. An object-side surface S5 of the third lens E3 is a concave surface, and an image-side surface S6 of the third lens E3 is a convex surface. The fourth lens E4 has a positive refractive power. An object-side surface S7 of the fourth lens E4 is a convex surface, and an image-side surface S8 of the fourth lens E4 is a concave surface. The optical filter E5 has an object-side surface S9 and an image-side surface S10. Light from an object sequentially passes through the respective surfaces Sb to S10 and is finally imaged on the imaging plane S11.

Table 11 shows a basic parameter table of the optical lens group in example 6, wherein the units for the radius of curvature, the thickness and the focal length are millimeter (mm). Table 12 shows high-order coefficients applicable to each aspheric surface in example 6, wherein the surface shape of each aspheric surface may be defined by the formula (1) given in the above example 1.

TABLE 11
Example 6: f = 2.10 mm, ImgH = 1.58 mm, Semi-FOV = 35.5°

| | | | | Material | | | |
|---|---|---|---|---|---|---|---|
| Surface | Surface | Radius of | | Refractive | Abbe | Focal | Conic |
| number | type | curvature | Thickness | index | number | length | coefficient |
| OBJ | spherical | infinite | 800.0000 | | | | |
| S1 | aspheric | 1.2105 | 0.4465 | 1.57 | 30.19 | 4.69 | −0.8550 |
| S2 | aspheric | 1.9315 | 0.1195 | | | | −7.7426 |
| STO | spherical | infinite | 0.1418 | | | | |
| S3 | aspheric | 1.5478 | 0.3779 | 1.62 | 23.53 | 115.47 | −2.5946 |
| S4 | aspheric | 1.4347 | 0.1824 | | | | 0.8290 |
| S5 | aspheric | −100.0000 | 0.4394 | 1.53 | 56.07 | −2931.93 | 99.0000 |
| S6 | aspheric | −107.0971 | 0.1311 | | | | −99.0000 |
| S7 | aspheric | 0.6331 | 0.3813 | 1.62 | 23.53 | 2.87 | −6.2689 |
| S8 | aspheric | 0.7587 | 0.2329 | | | | −1.2734 |
| S9 | spherical | infinite | 0.2121 | 1.51 | 64.17 | | |
| S10 | spherical | infinite | 0.4374 | | | | |
| S11 | spherical | infinite | | | | | |

TABLE 12

| Sur- | | | | | | | | | |
|---|---|---|---|---|---|---|---|---|---|
| face | | | | | | | | | |
| num- | | | | | | | | | |
| ber | A4 | A6 | A8 | A10 | A12 | A14 | A16 | A18 | A20 |
| S1 | −1.3514E−01 | 1.9354E+00 | −1.3477E+01 | 5.3198E+01 | −1.2587E+02 | 1.8078E+02 | −1.5349E+02 | 6.9864E+01 | −1.2949E+01 |
| S2 | −3.1433E−02 | −1.3309E+00 | 9.1981E+00 | −3.6957E+01 | 8.7245E+01 | −1.2371E+02 | 1.0159E+02 | −4.3408E+01 | 7.2247E+00 |
| S3 | −3.6008E−01 | 2.4646E−01 | −4.1646E+00 | 1.1766E+01 | −8.1962E+00 | −2.7645E+01 | 7.3296E+01 | −6.6394E+01 | 2.1127E+01 |
| S4 | −2.9618E−01 | 1.4993E+00 | −1.6348E+01 | 7.6172E+01 | −2.1398E+02 | 3.7236E+02 | −3.9360E+02 | 2.3389E+02 | −6.0179E+01 |
| S5 | −3.6581E−01 | 5.9361E+00 | −4.2215E+01 | 1.7294E+02 | −4.3611E+02 | 6.6486E+02 | −5.8966E+02 | 2.7895E+02 | −5.4364E+01 |
| S6 | −3.3090E+00 | 1.8285E+01 | −7.4988E+01 | 2.1471E+02 | −4.1061E+02 | 5.0280E+02 | −3.7163E+02 | 1.4950E+02 | −2.5014E+01 |
| S7 | −6.0854E−01 | 1.6728E−01 | 1.0646E+00 | −2.3936E+00 | 2.4922E+00 | −1.4043E+00 | 4.3024E−01 | −6.6520E−02 | 3.9915E−03 |
| S8 | −9.2566E−01 | 6.1943E−01 | 1.0923E+00 | −3.7977E+00 | 5.2517E+00 | −4.1599E+00 | 1.9492E+00 | −5.0195E−01 | 5.4744E−02 |

FIG. 12A illustrates a longitudinal aberration curve of the optical lens group according to example 6, representing deviations of focal points converged by light of different wavelengths after passing through the optical lens group. FIG. 12B illustrates an astigmatic curve of the optical lens group according to example 6, representing a curvature of a tangential plane and a curvature of a sagittal plane. FIG. 12C illustrates a distortion curve of the optical lens group according to example 6, representing amounts of distortion at different FOVs. It can be seen from FIG. 12A to FIG. 12C that the optical lens group provided in example 6 may achieve good image quality.

In view of the above, examples 1 to 6 respectively satisfy the relationship shown in Table 13.

TABLE 13

| Condition\ | | | | | | |
|---|---|---|---|---|---|---|
| Example | 1 | 2 | 3 | 4 | 5 | 6 |
| R4/R3 | 1.44 | 1.68 | 0.93 | 1.45 | 0.93 | 0.93 |
| f/EPD | 1.157 | 1.156 | 1.296 | 1.156 | 1.296 | 1.296 |
| TTL/ImgH | 2.05 | 2.09 | 2.00 | 2.06 | 1.96 | 1.96 |
| R7*10/R8 | 6.66 | 6.12 | 7.68 | 8.65 | 8.27 | 8.34 |
| f4/R7 | 3.44 | 3.08 | 3.93 | 5.96 | 4.44 | 4.53 |
| f4/f | 1.08 | 0.95 | 1.11 | 1.95 | 1.33 | 1.37 |
| CT3/CT4 | 1.20 | 1.21 | 0.89 | 1.93 | 1.14 | 1.15 |
| CT1/T12 | 2.18 | 3.06 | 1.43 | 2.08 | 1.72 | 1.71 |
| T23*10/TTL | 1.19 | 1.18 | 0.70 | 0.85 | 0.59 | 0.59 |
| T12/T34 | 1.50 | 1.32 | 3.05 | 1.40 | 1.99 | 1.99 |
| SAG21/SAG22 | 1.11 | 1.29 | 0.43 | 1.03 | 0.39 | 0.38 |
| ΣAT/TD | 0.32 | 0.28 | 0.31 | 0.28 | 0.26 | 0.26 |

The present disclosure further provides an imaging apparatus, having a photosensitive element which may be a photosensitive Charge-Coupled Device (CCD) or a Complementary Metal-Oxide Semiconductor (CMOS). The imaging apparatus may be an independent imaging device such as a digital camera, or may be an imaging module integrated in a mobile electronic device such as a mobile phone. The imaging apparatus is equipped with the optical lens group described above.

The foregoing is only a description of the preferred examples of the present disclosure and the applied technical principles. It should be appreciated by those skilled in the art that the inventive scope of the present disclosure is not limited to the technical solutions formed by the particular combinations of the above technical features. The inventive scope should also cover other technical solutions formed by any combinations of the above technical features or equivalent features thereof without departing from the concept of the invention, such as, technical solutions formed by replacing the features as disclosed in the present disclosure with (but not limited to), technical features with similar functions.

What is claimed is:

1. An optical lens group, comprising: a first lens, a second lens, a third lens and a fourth lens, which have refractive power and are sequentially arranged from an object side to an image side of the optical lens group along an optical axis of the optical lens group,
wherein,
an object-side surface of the first lens is a convex surface and an image-side surface of the first lens is a concave surface;
an image-side surface of the second lens is a concave surface;
the fourth lens has a positive refractive power, an object-side surface of the fourth lens is a convex surface, and an image-side surface of the fourth lens is a concave surface, wherein at least one of the object-side surface and the image-side surface of the fourth lens has a inflection point;
the optical lens group further comprises a stop disposed between the first lens and the second lens; and
wherein 0.50<R4/R3<2.00, where R4 is a radius of curvature of the image-side surface of the second lens and R3 is a radius of curvature of an object-side surface of the second lens.

2. The optical lens group according to claim 1, wherein f/EPD<1.30,
where f is a total effective focal length of the optical lens group and EPD is an entrance pupil diameter of the optical lens group.

3. The optical lens group according to claim 1, wherein TTL/ImgH<2.10,
where TTL is a distance along the optical axis from the object-side surface of the first lens to an imaging plane of the optical lens group, and ImgH is half of a diagonal length of an effective pixel area of the electronic photosensitive element on the imaging plane of the optical lens group.

4. The optical lens group according to claim 1, wherein 6.00<(R7*10)/R8<9.00,
where R7 is a radius of curvature of the object-side surface of the fourth lens and R8 is a radius of curvature of the image-side surface of the fourth lens.

5. The optical lens group according to claim 1, wherein 3.00<f4/R7<6.00,
where f4 is an effective focal length of the fourth lens and R7 is a radius of curvature of the object-side surface of the fourth lens.

6. The optical lens group according to claim 1, wherein 0.50<f4/f<2.00,
where f4 is an effective focal length of the fourth lens and f is a total effective focal length of the optical lens group.

7. The optical lens group according to claim 1, wherein 0.50<CT3/CT4<2.00,
where CT3 is a center thickness of the third lens along the optical axis and CT4 is a center thickness of the fourth lens along the optical axis.

8. The optical lens group according to claim 1, wherein 1.00<CT1/T12<3.50,
where CT1 is a center thickness of the first lens along the optical axis and T12 is a spaced interval between the first lens and the second lens along the optical axis.

9. The optical lens group according to claim 1, wherein 0.50<(T23*10)/TTL<1.50,
where T23 is a spaced interval between the second lens and the third lens along the optical axis and TTL is a distance along the optical axis from the object-side surface of the first lens to an imaging plane of the optical lens group.

10. The optical lens group according to claim 1, wherein 1.00<T12/T34<3.50,
where T34 is a spaced interval between the third lens and the fourth lens along the optical axis and T12 is a spaced interval between the first lens and the second lens along the optical axis.

11. The optical lens group according to claim 1, wherein 0.30<SAG21/SAG22<1.50,
where SAG21 is an axial distance from an intersection of the object-side surface of the second lens and the optical axis to an apex of an effective radius of the object-side surface of the second lens, and SAG22 is an axial distance from an intersection of the image-side surface of the second lens and the optical axis to an apex of an effective radius of the image-side surface of the second lens.

12. The optical lens group according to claim 1, wherein ΣAT/TD<0.35,
where ΣAT is a sum of spaced intervals along the optical axis between adjacent lenses of the first lens to the fourth lens, and TD is a distance along the optical axis from the object-side surface of the first lens to the image-side surface of the fourth lens.
